(19) United States
(12) Patent Application Publication
(10) Pub. No.: US 2014/0126494 A1
(43) Pub. Date: May 8, 2014

(54) BROADCAST CHANNEL CONFIGURATION IN WIRELESS COMMUNICATIONS

(71) Applicant: BROADCOM CORPORATION, Irvine, CA (US)

(72) Inventor: Gilles CHARBIT, Farnborough (GB)

(73) Assignee: BROADCOM CORPORATION, Irvine, CA (US)

(21) Appl. No.: 14/063,074

(22) Filed: Oct. 25, 2013

(30) Foreign Application Priority Data
Nov. 2, 2012 (GB) 1219791.9

(51) Int. Cl. H04L 5/00

(52) U.S. Cl. CPC H04L 5/0098
USPC 370/329

(57) ABSTRACT

Measures for a broadcast channel configuration of a standalone carrier may exemplarily include measures for configuring a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and measures for scheduling common control signaling in the one subset of physical resource blocks in accordance with the configured broadcast channel of the carrier.

### CROSS REFERENCE TO RELATED APPLICATION

This application claims the benefit under 35 U.S.C. §119(a) and 37 CFR §1.55 to UK Patent Application No. 1219791.9, filed on Nov. 2, 2012, the entire content of which is incorporated herein by reference.

### TECHNICAL FIELD

The present invention relates to wireless communications and specifically, although not exclusively, to broadcast channel configuration of a standalone carrier. Exemplary embodiments of invention relate to measures (including methods, apparatuses and computer program products) for realizing a broadcast channel configuration of a standalone carrier.

### BACKGROUND

In the development of cellular communication systems, a focus is on increasing bandwidth and throughput in the radio access network, while enhancing system coverage and performance. In this regard, the concept of carrier aggregation (CA) is developed.

In carrier aggregation, multiple component carriers (which may be referred to as legacy carriers) are combined as a primary component carrier (PCC) and at least one secondary component carrier (SCC). In such combination of aggregated (legacy) component carriers, the PCC has to have means for the provision of system information, paging and random access procedures, e.g. a broadcast channel (BCH) and a common search space (CSS) for an enhanced physical downlink control channel (ePDCCH).

In the development of carrier aggregation, a new type of carrier is considered to be desirable, which is non-backwards compatible, i.e. which does not include any backwards compatible elements. Such new carrier type (NCT) could provide for CA enhancements, as the support of legacy terminals would not be required.

While such new carrier type for CA may be required to be aggregated with a legacy carrier as a primary carrier which enables the provision of system information, it is preferable that such new carrier type for CA is operable as a standalone carrier, i.e. a carrier which is not required to be aggregated with a legacy carrier as a primary carrier. Such standalone carrier, which could thus not be assumed to be aggregated with a legacy carrier, would have to have its own means for the provision of system information, paging and random access procedures, e.g. a broadcast channel (BCH) and a CSS for an ePDCCH.

The present specification relates to an appropriate configuration of a broadcast channel for a carrier, which may for example be a new LTE/LTE-A carrier type applicable for carrier aggregation, in view of the subsequent considerations.

Generally, in the configuration of the BCH for legacy carriers, each cell (i.e. eNB) schedules the Master Information Block (MIB) mapped to the Physical Broadcast Channel (PBCH) in fixed time-domain resources in the middle 6 Physical Resource Blocks (PRBs) in the system bandwidth in the frequency domain. Likewise, each cell (i.e. eNB) schedules the System Information Block type 1 (SIB1) in a system information message mapped to the Downlink Shared Channel (DL-SCH) in fixed time-domain resources in the middle 6 Physical Resource Blocks (PRBs) in the system bandwidth in the frequency domain. Accordingly, inter-cell interference on the BCH is a known problem for legacy carriers. Specifically, it is at least difficult to avoid inter-cell interference on MTB and SIB1 on the BCH for legacy carriers, which may have negative impacts e.g. on cell-edge terminals.

Therefore, it is desirable, for example, to reduce inter-cell interference on the BCH, which demand is equally applicable for a new carrier type of a standalone carrier which requires its own BCH.

Thus, there is a need for an enhanced broadcast channel configuration of a standalone carrier.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a wireless communication method including: configuring a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and scheduling common control signaling in the one subset of physical resource blocks in accordance with the configured broadcast channel of the carrier.

According to an exemplary aspect of the present invention, there is provided a wireless communication method including: detecting a broadcast channel of a carrier in one of a predetermined number of subsets of physical resource blocks in a system bandwidth, wherein each subset includes the same prescribed number of physical resource blocks and the predetermined number of subsets are distributed in the frequency domain to cover the system bandwidth with the center of the system bandwidth being located in the center of a middle subset, and listening for common control signaling in the one subset of physical resource blocks in accordance with the detected broadcast channel of the carrier.

According to an exemplary aspect of the present invention, there is provided an apparatus (which may e.g. be arranged/configured for use on a network side of a cellular communication system), the apparatus arranged/configured to:: configure a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and schedule common control signaling in the one subset of physical resource blocks in accordance with the configured broadcast channel of the carrier.

According to an exemplary aspect of the present invention, there is provided an apparatus (which may e.g. be arranged/configured for use on a terminal side of a cellular communication system) arranged to:: detect a broadcast channel of a carrier in one of a predetermined number of subsets of physical resource blocks in a system bandwidth, wherein each subset includes the same prescribed number of physical resource blocks and the predetermined number of subsets are distributed in the frequency domain to cover the system bandwidth with the center of the system bandwidth being located in the center of a middle subset, and listen for common control signaling in the one subset of physical resource blocks in accordance with the detected broadcast channel of the carrier.

The processing system according to any one of the aforementioned apparatus-related exemplary aspects of the present invention may for example include at least one processor and at least one memory including computer program code (and, optionally, at least one transceiver or interface configured for communication with at least another apparatus), wherein the at least one processor, with the at least one memory and the computer program code, is arranged/configured to cause the apparatus to perform as described herein.

According to an exemplary aspect of the present invention, there is provided an apparatus including: means for configuring a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and means for scheduling common control signaling in the one subset of physical resource blocks in accordance with the configured broadcast channel of the carrier.

According to an exemplary aspect of the present invention, there is provided an apparatus including: means for detecting a broadcast channel of a carrier in one of a predetermined number of subsets of physical resource blocks in a system bandwidth, wherein each subset includes the same prescribed number of physical resource blocks and the predetermined number of subsets are distributed in the frequency domain to cover the system bandwidth with the center of the system bandwidth being located in the center of a middle subset, and means for listening for common control signaling in the one subset of physical resource blocks in accordance with the detected broadcast channel of the carrier.

According to an exemplary aspect of the present invention, there is provided a computer program product including computer-executable computer program code which, when executed on an apparatus or a computer of an apparatus (e.g. an apparatus according to any one of the aforementioned apparatus-related exemplary aspects of the present invention), is arranged/configured to cause the computer or apparatus to carry out the method according to any one of the aforementioned method-related exemplary aspects of the present invention.

Such computer program product may for example include or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By virtue of the aforementioned exemplary aspects of the present invention, there is provided an enhanced broadcast channel configuration of a standalone carrier.

Accordingly, there is provided a broadcast channel configuration of a standalone carrier, which is effective for reducing inter-cell interference on the broadcast channel. Such broadcast channel configuration is applicable for a standalone carrier/operation of a non-backwards compatible LTE/LTE-A carrier type for carrier aggregation, for which it may be taken advantage of the lacking requirement of support of legacy terminals.

Thus, for example, improvements, e.g. in terms of inter-cell interference, may be achieved by methods, apparatuses and computer program products capable of enabling/realizing an enhanced broadcast channel configuration of a standalone carrier.

### BRIEF DESCRIPTION OF DRAWINGS

For a more complete understanding of the present invention, reference is now made to the following description of some example embodiments taken in connection with the accompanying drawings in which:

FIG. 1 is a signaling diagram illustrating a first example procedure of according to some example embodiments of the present invention,

FIG. 2 is a schematic diagram illustrating an arrangement of subsets of physical resource blocks in a system bandwidth according to some example embodiments of the present invention,

FIG. 3 is a schematic diagram illustrating an allocation of subsets of physical resource blocks for a coordination of broadcast channels according to some example embodiments of the present invention,

FIG. 4 is a signaling diagram illustrating a second example procedure of according to some example embodiments of the present invention, and

FIG. 5 is a schematic block diagram illustrating example apparatuses according to some example embodiments of the present invention.

### DETAILED DESCRIPTION

Exemplary aspects of the present invention will be described herein below. More specifically, some exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the examples and example embodiments of the present invention mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-A communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, some example embodiments of the present invention may be applicable in any communication system and/or network deployment in which carrier/channel aggregation is or could be applicable. Such communication system and/or network deployment could for example include those in accordance with IEEE 802.11. For example, application to an IEEE 802.11 ah system could be conceivable, which supports 1 MHz, 2 MHz, 4 MHz, 8 MHz, and 16 MHz channel bandwidths and OFDM PHY with 31.25 kHz tone spacing, wherein there could be adopted carrier aggregation (or channel aggregation).

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to example embodiments of the present invention, in general terms, there are provided mechanisms, measures and means for enabling/realizing an enhanced broadcast channel configuration of a standalone carrier.

In the following, example embodiments of the present invention are described with reference to methods, procedures and functions, as well as with reference to structural arrangements and configurations.

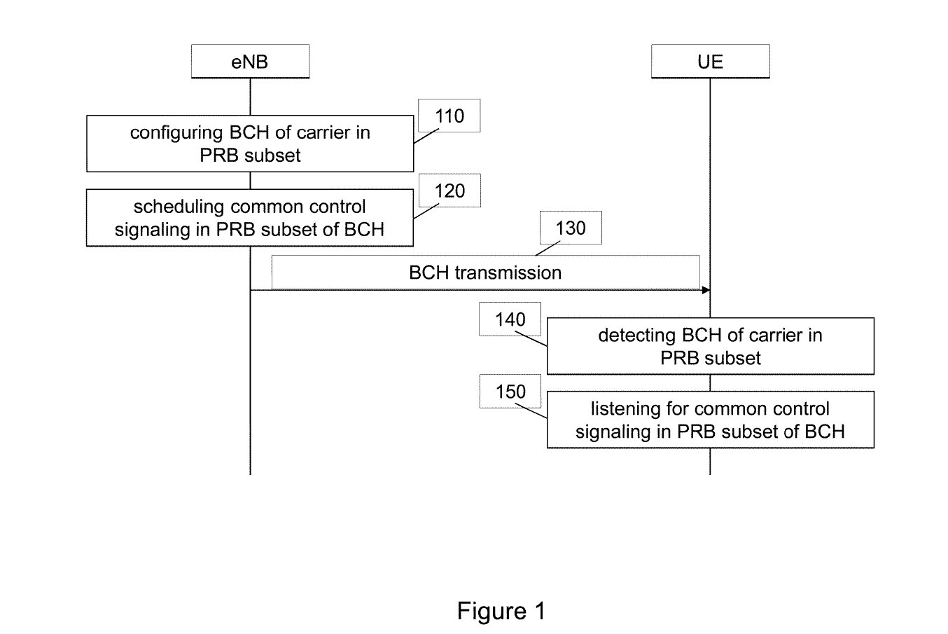

FIG. 1 shows a signaling diagram illustrating a first example procedure of according to some example embodiments of the present invention.

As shown in FIG. 1, an example procedure according to some example embodiments of the present invention may include the following operations. The thus exemplified procedure is applicable between a base station such as an eNB and a terminal such as an UE in a cellular communication system such as a LTE/LTE-A communication system.

At the network side, the eNB configures a broadcast channel (BCH) of a carrier in one of a predetermined number of subsets of physical resource blocks (PRBs) in a system bandwidth on the basis of a cell configuration (operation 110), and schedules common control signaling (broadcast information) in the one subset of PRBs in accordance with the configured BCH of the carrier (operation 120). Then, a BCH transmission from the eNB to the UE may be accomplished using the scheduled common control signaling on the configured broadcast channel (operation 130). At the terminal side, the UE detects the BCH of the carrier in the one of the predetermined number of subsets of PRBs in the system bandwidth (operation 140), and listens for (or monitors) common control signaling (broadcast information) in the one subset of PRBs in accordance with the detected BCH of the carrier (operation 150).

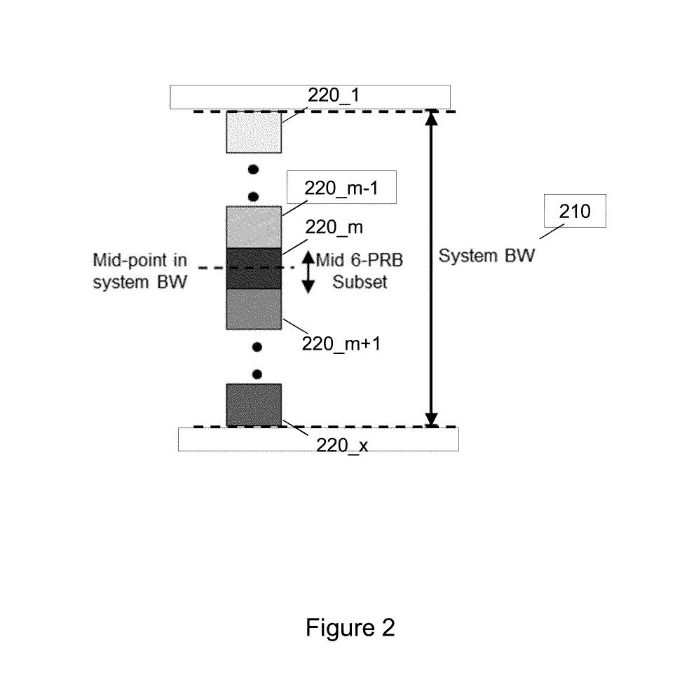

The aforementioned configuring and detecting operations are based on an arrangement of subsets of physical resource blocks in a system bandwidth according to some example embodiments of the present invention, as illustrated in FIG. 2.

As shown in FIG. 2, a system bandwidth 210 is divided into PRB subsets 220 (220_1, . . . , 220_{—}m−1, 220_{—}m, 220_{—}m+1, . . . , 220_{—}x) of equal size (each including e.g. 6 PRBs) in the frequency domain. That is, each PRB subset 220 includes the same prescribed number of (e.g. 6) PRBs, and the predetermined number of PRB subsets are distributed in the frequency domain around the center of the system bandwidth, i.e. to cover the system bandwidth with the center of the system bandwidth being located in the center of a middle PRB subset.

Assuming that each PRB subset contains 6 PRBS, the predetermined number of PRB subsets in the system bandwidth, i.e. N_{subset}, may be derived as follows.

$${N}_{subset} = ⌊ \frac{{N}_{RB}^{max , DL}}{6} ⌋$$

where N^{max,DL}_{RB} is the maximum number of PRBs in the system bandwidth, with 6≦N^{max,DL}_{RB}≦110, as specified e.g. in 3GPP TS 36.211, and ␣ is the floor operator. Thus, the PRB subset 220_{—}x is the N_{subset}-th PRB subset in the system bandwidth.

As the BCH is configured in only one PRB subset out of the N^{max,DL}_{RB} available PRB subsets in the system bandwidth, the BCH of the eNB/cell in question may be a PRB subset other than the middle PRB subset (i.e. 220_{—}m), i.e. the middle 6 PRBs, as specified for legacy carriers. Further, as the PRB subset for the eNB/cell in question is determined on the basis of a cell configuration, the BCH of multiple (neighboring) eNBs/cells could be dispersed over the system bandwidth, thereby reducing inter-cell interference on the BCH. Thereby, a L1 signaling optimization between eNBs/cells could be realized, which could be achieved via the X2 interface between the individual eNBs, while the S1 interface between any eNB and the EPC may not be affected.

A flexible x-PRB subset BCH configuration (e.g. x=6) as outlined above may build the basis for an appropriate provision of system information via the broadcast channel.

Firstly, a master information block of the common control signaling, i.e. the MIB, could be provided in the one PRB subset according to the BCH of the subject eNB. That is, the MIB may be scheduled and transmitted by the eNB, and it may be listened for (or monitored) and obtained by the UE accordingly. Specifically, the MIB may be carried on the PBCH (which is located in the first subframe, i.e. subframe 0, of each radio frame).

Secondly, a system information block of the common control signaling, i.e. the SIBx (x=1, 2, . . . ), could be provided in the one PRB subset according to the BCH of the subject eNB. That is, the SIBx in SI messages may be scheduled and transmitted by the eNB (being scrambled with SI-RNTI), and it may be listened for (or monitored) and obtained by the UE accordingly. Specifically, the SIBx may be carried on the PDSCH.

Further, the PDSCH may carry additional system information. For example, a paging message may be scheduled and transmitted by the eNB (being scrambled with P-RNTI), and it may be listened for (or monitored) and obtained by the UE accordingly. For example, a RACH response message may be scheduled and transmitted by the eNB (being scrambled with RA-RNTI), and it may be listened for (or monitored) and obtained by the UE accordingly. For example, a transmit power control (TPC) message may be scheduled and transmitted by the eNB (being scrambled with TPC-RNTI), and it may be listened for (or monitored) and obtained by the UE accordingly.

Accordingly, due to avoiding interference or, stated in other words, dispersing potential interference over a number of PRB subsets in the system bandwidth by way of the BCH configuration as described herein, the PBCH and/or the PDSCH may be decoded at a very low SNR.

Thirdly, a CSS for an ePDCCH could be formed with respect to the one PRB subset according to the BCH of the subject eNB. That is, the CSS of the ePDCCH may be formed (implicitly) by the eNB, and it may be listened for (or monitored) by the UE accordingly. Specifically, the CSS of the ePDCCH may be centered around a center of the PRB subset in question, which is the PRB subset in which the MIB and or any SIBx may be contained. Thereby, an implicit position of the CSS of the ePDCCH in the frequency domain may be provided, which is why no explicit signaling in this regard is required so as to enable the terminal to enable obtaining the scheduling assignments carried by the ePDCCH (being transmitted either in localized or distributed manner).

The aforementioned cell configuration, upon which the BCH configuration is based, may be any configuration parameter of a (physical) cell of the eNB. For example, such cell configuration is issued, which is not likely to be changed for a relatively long time (e.g. for some days). For example, the physical cell identity (PCI) of the cell of the eNB may be used as the cell configuration.

Accordingly, the BCH may be configured (in the one PRB subset) on the basis of a physical cell identity, i.e. N^{cell}_{ID}, and the number of subsets in the system bandwidth, i.e. N_{subset}. For example, the allocation of a PRB subset for eNB/cell i, i.e. Subsetᵢ, may be derived using the modulo operator as follows.

Subsetᵢ=N_{ID}^{cell} mod N_{subsets}

It is to be noted that different subsets of PRBs could be allocated to multiple (neighboring) eNBs. Yet, e.g. in a deployment with a larger system bandwidth, different subsets of PRB pairs could be allocated different to multiple (neighboring) eNBs.

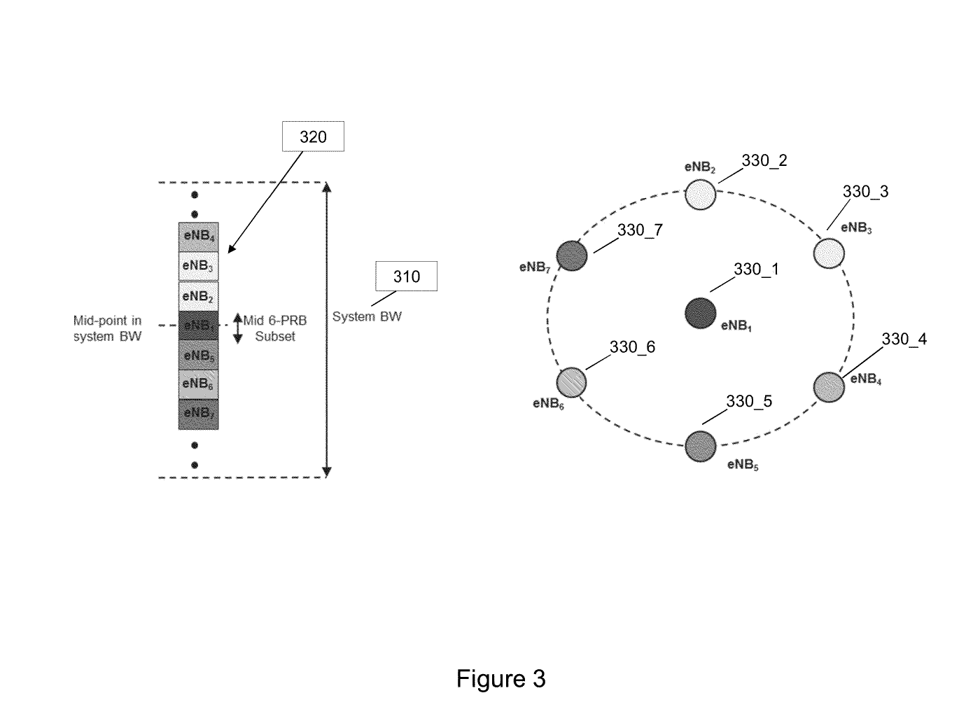

Such BCH configuration may result in an allocation of subsets of physical resource blocks for a coordination of broadcast channels according to some example embodiments of the present invention, as illustrated in FIG. 3.

As shown in FIG. 3, the PRB subsets 320 being allocated for eNBs/cells 1 to 7 within the system bandwidth 310 are exemplified for illustrative purposes on the left side, while a resulting arrangement of common search spaces 330 (330_1 to 330_7) according to the PRB subset allocation is exemplified for illustrative purposes on the right side. Accordingly, FIG. 3 schematically illustrates that a dispersed allocation of PRB subsets 320 to eNBs/cells 1 to 7 results in a distributed set of common search spaces for eNBs/cells 1 to 7.

Accordingly, using the physical cell identity being assigned by/m the E-UTRAN, a coordination of BCH configuration, i.e. determination of the 6-PRB subset containing the common control signaling (e.g. MIB, SIBx, and ePDCCH in CSS), between multiple eNBs is enabled. Thereby, inter-cell interference on the common control signaling may be mitigated. The E-UTRAN may assign, or in the E-UTRAN there may be assigned, physical cell identities to multiple (neighboring) cells to ensure that their MIB/SIB transmissions according to their BCH configurations are multiplexed in the frequency domain, i.e. contained in different 6-PRB subsets, as much as can be. In this regard, configuration of the ePDCCH CSS can be also coordinated between multiple eNBs to limit inter-cell interference to the ePDCCH in the CSS.

It is noted that an assignment of physical cell identities to eNBs in/by the E-UTRAN may be accomplished by an OAM function or entity in/of the E-UTRAN. In general terms, PCI assignment may be centralized, i.e. the OAM function or entity may specifically assign and signal a specific PCI value to each eNB, or PCI assignment may be distributed, i.e. the OAM function or entity may signal a list of potential PCI value to each eNB and each eNB may select its PCI value from the list of potential PCI values given by the OAM function or entity based on some criterion (such as e.g. UE reports, X2 interface reports, some dedicated acquisition technique, or the like).

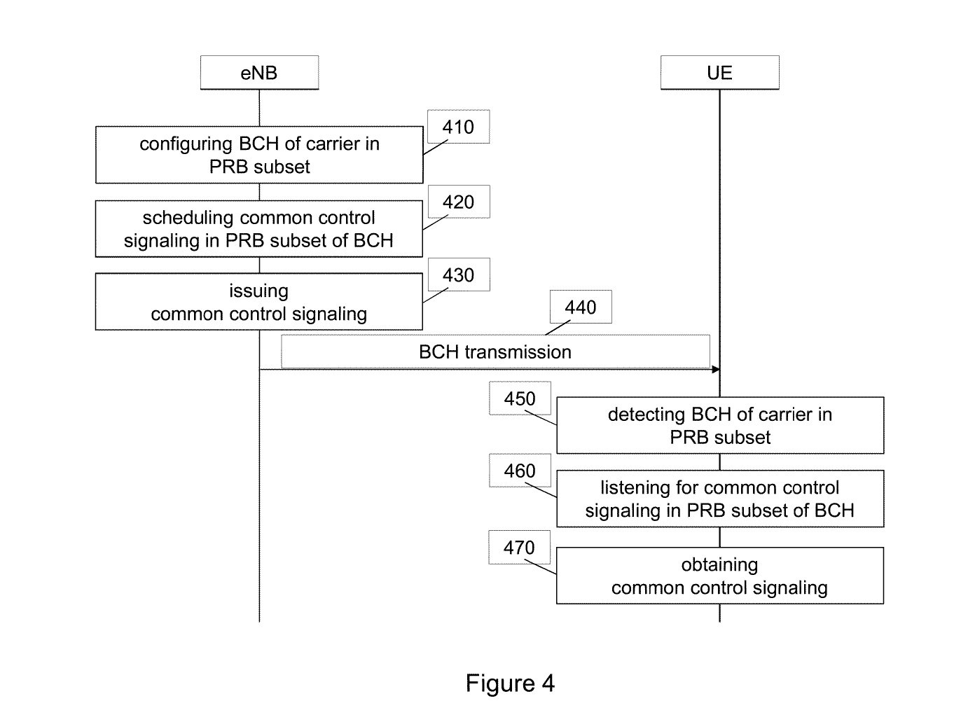

FIG. 4 shows a signaling diagram illustrating a second example procedure of according to some example embodiments of the present invention.

As shown in FIG. 4, an example procedure according to some example embodiments of the present invention may include the following operations. The thus exemplified procedure is applicable between a base station such as an eNB and a terminal such as an UE in a cellular communication system such as a LTE/LTE-A communication system. The operations 410, 420, 440, 450 and 460 according to FIG. 4 may basically correspond to the operations 110 to 150 according to FIG. 1, respectively. Hence, a description thereof is not repeated, but reference is made to the above description of FIG. 1 accordingly.

At the network side, the eNB may additionally issue scheduled common control signaling (or initiate a (BCH) transmission of scheduled common control signaling in the one PRB subset) (operation 430) such that the scheduled common control signaling is transmitted with a predefined timing and scrambling scheme and/or with a predefined synchronization scheme and/or with the same at least one antenna port for the common control signaling in one or more of a master information block, a system information block and an enhanced physical downlink control channel. Accordingly, at the terminal side, the UE may additionally obtain the common control signaling in the one PRB subset (operation 470) after receiving the (BCH) transmission of the common control signaling with a predefined timing and scrambling scheme and/or with a predefined synchronization scheme and/or with the same at least one antenna port for the common control signaling in one or more of a master information block, a system information block and an enhanced physical downlink control channel. Further details in this regard are outlined hereinafter.

The timing of the BCH transmission and the scrambling of the BCH payload (i.e. the common control signalling) with the physical cell identity could be as specified for legacy carriers.

Accordingly, in detecting the BCH, the UE may detect a synchronization signal in the middle PRB subset in the system bandwidth, and may detect a MIB in each subset of PRBs in the system bandwidth after detection of the synchronization signal. For example, the UE tries a blind MIB detection in each 6-PRB subset following a PSS/SSS detection in the middle 6-PRB subset, and checks whether or not there was an erroneous PSS/SSS detection using MIB CRC. A false detection is avoided by a fixed timing of the MIB relative to PSS/SSS, MIB CRC checking, and scrambling of BCH payload with the physical cell identity.

Further, the UE may detect a SIBx which is contained in SI messages transmitted on the PDSCH as indicated by DL grant on the ePDCCH in the CSS. In this regard, UEs blindly decode the ePDCCH in the CSS and check the CRC of the ePDCCH which is scrambled with SI-RNTI. The SIB1 is located in a fixed time domain position. The SIBx (x=2, 3, 4, . . . ) are transmitted periodically in non-overlapping time-domain SI windows. The length of SI windows, the periodicity of SI windows, and a list of SIBx (x=3, 4, . . . ) scheduled in the SI windows is indicated in SIB1, while the SIB2 is not listed in SIB1 because of being always transmitted in the first entry of the first SI message.

Still further, the UE may detect a paging message transmitted on the PDSCH as indicated by DL grant on the ePDCCH in the CSS. In this regard, UEs blindly decode the ePDCCH in the CSS and check the CRC of ePDCCH which is scrambled with P-RNTI.

Still further, the UE may detect a RACH response message transmitted on the PDSCH as indicated by DL grant on the ePDCCH in the CSS. In this regard, UEs blindly decode the ePDCCH in the CSS and check the CRC of ePDCCH which is scrambled with RA-RNTI.

Still further, the UE may detect a transmit power control (TPC) message transmitted on the PDSCH as indicated by DL grant on the ePDCCH in the CSS. In this regard, UEs blindly decode the ePDCCH in the CSS and check the CRC of ePDCCH which is scrambled with TPC-RNTI.

The synchronization of the BCH transmission could be as specified for legacy carriers.

Accordingly, a specified synchronization signal, such as PSS/SSS, may be used for synchronization. Reusing such specified synchronization signal is applicable for an application to a new carrier type, as described above. This is because a standalone carrier of such new carrier type is not aggregated with any legacy carrier, and hence it cannot be assumed to be pre-synchronized based on a synchronization of/to the legacy carrier. Further, requirements for synchronization on a standalone carrier of such new carrier type are assumed to be similar to that for a legacy carrier.

The antenna port configuration used for the BCH transmission (i.e. the common control signaling) could be as specified for legacy carriers.

Accordingly, the same at least one antenna port may be used for the broadcast information in one or more of the MIB, the SIBx and the ePDCCH. Thereby, as indicated above, the antenna port/s used by the ePDCCH in the CSS is/are determined implicitly to be the same as the antenna port/s used for the MIB transmission on the subject carrier. The ePDCCH in USS can be configured to be mapped to different antenna ports based on the C-RNTI in case of overlapping CSS and USS, or some other way. Further, the E-UTRAN may coordinate the mapping of antenna ports such that multiple (neighboring) eNBs may use different antenna ports for the ePDCCH in the CSS. Such antenna port mapping may be achieved by the eNBs via the X2 interface between the individual eNBs.

As outlined above, by virtue of at least some example embodiments of the present invention, there is provided a broadcast channel configuration of a standalone carrier, which is effective for reducing inter-cell interference on the broadcast channel.

Such broadcast channel configuration according to at least some example embodiments of the present invention is applicable LTE/LTE-A Rel-11, Rel-12 and/or onwards. More specifically, such broadcast channel configuration according to at least some example embodiments of the present invention is exemplarily applicable for a standalone carrier/operation of a non-backwards compatible LTE/LTE-A carrier type for carrier aggregation, for the BCH enhancements of which it may be taken advantage of the lacking requirement of support of legacy terminals.

Accordingly, inter-cell interference coordination on PRB subsets containing the system information (i.e. common control signaling or broadcast information) between multiple (neighboring) cells may be achieved. And, an implicit position of the CSS in the frequency domain (and, thus, an improved mapping of antenna ports) may be realized.

A standalone carrier/operation of a non-backwards compatible LTE/LTE-A carrier type for carrier aggregation, i.e. a new carrier type, supports non-CA terminals, and provides for relaxed RF requirements and lower costs (thus providing an advantage in view of the fact that current pico cell requirements are as strict as macro cell requirements), as well as for standalone local access (i.e. all connections from a local-access node) and lean macro cells e.g. in rural areas (i.e. more efficient downlink signaling).

A standalone carrier/operation of a non-backwards compatible LTE/LTE-A carrier type for carrier aggregation, i.e. a new carrier type, for which a broadcast channel configuration according to at least some example embodiments of the present invention is applied, does not require use of the PDCCH. Accordingly, only support of the ePDCCH is required for such configured carrier.

Generally, the above-described procedures and functions may be implemented by respective functional elements, processors, processing systems, or the like, as described below.

While in the foregoing some example embodiments of the present invention are described mainly with reference to methods, procedures and functions, corresponding example embodiments of the present invention also cover respective apparatuses, network nodes and systems, including both software and/or hardware thereof.

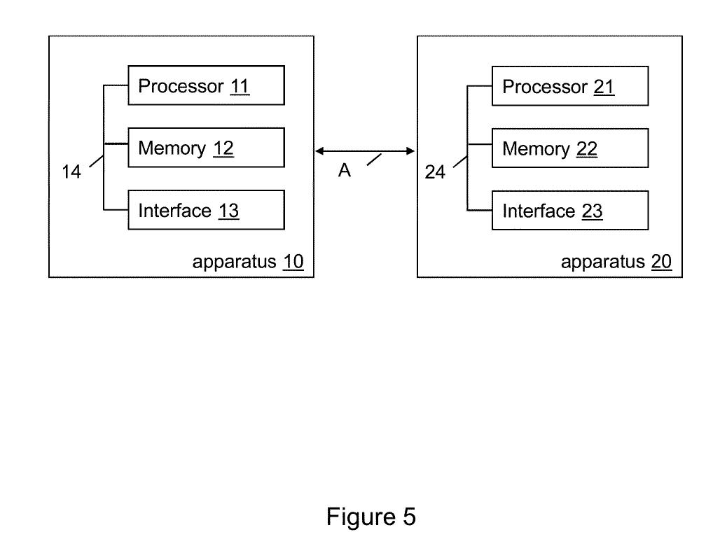

Respective some example embodiments of the present invention are described below referring to FIG. 5, while for the sake of brevity reference is made to the detailed description with regard to FIGS. 1 to 4.

In FIG. 5 below, which is noted to represent a simplified block diagram, the solid line blocks are basically configured to perform respective operations as described above. The entirety of solid line blocks are basically configured to perform the methods and operations as described above, respectively. With respect to FIG. 5, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also include an arbitrary number of intermediary functional entities not shown. The direction of arrow is meant to illustrate the direction in which certain operations are performed and/or the direction in which certain data is transferred.

Further, in FIG. 5, only those functional blocks are illustrated, which may relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 5 shows a schematic block diagram illustrating example apparatuses according to some example embodiments of the present invention.

In view of the above, the thus illustrated apparatuses 10 and 20 are suitable for use in practicing example embodiments of the present invention, as described herein.

The thus illustrated apparatus 10 corresponds to an entity which may represent a (or part of a) communication control device such as a base station, e.g. an eNB, or a corresponding modem (which may be installed as part thereof, but may be also a separate module, which can be attached to various devices), and may be configured to perform a procedure and/or functionality as described in conjunction with any one of FIGS. 1 to 4. The thus illustrated apparatus 20 corresponds to an entity which may represent a (or part of a) communication device such as a terminal, e.g. an UE, or a corresponding modem (which may be installed as part thereof, but may be also a separate module, which can be attached to various devices), and may be configured to perform a procedure and/or functionality as described in conjunction with any one of FIGS. 1 to 4.

Generally, any apparatus according to some example embodiments of the present invention may include at least one processor, at least one memory including computer program code, and at least one interface (or transceiver) configured for communication with at least another apparatus. Further, in any apparatus according to some example embodiments of the present invention, at least one processor and at least one memory including computer program code, wherein the at least one processor, with the at least one memory and the computer program code, is configured to cause the apparatus to perform as described herein, may be considered as a processing system.

As indicated in FIG. 5, according to some example embodiments of the present invention, an apparatus includes one or more processors 11/21 and one or more memories 12/22, and may also include one or more interface(s) 13/23, which may be connected by a bus 14/24 or the like. Further, apparatuses may be connected via a corresponding link or connection A.

The processor(s) 11/21 and/or the interface(s) 13/23 may be facilitated for communication over a (hardwire or wireless) link, respectively. The interface(s) 13/23 may include a suitable receiver or a suitable transmitter-receiver combination or transceiver, which is coupled to one or more antennas or communication means for (hardwire or wireless) communications with the linked or connected device(s), respectively. The interface(s) 13/23 may be generally configured to communicate with another apparatus, i.e. the interface thereof.

The memory/memories 12/22 may store respective programs assumed to include program instructions or computer program code that, when executed by the respective processor, enables the respective electronic device or apparatus to operate in accordance with example embodiments of the present invention. For example, the memory/memories 12/22 of the apparatus 10/20 may store information on an arrangement of PRB subsets in the system bandwidth, or the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that a processor or processing system (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

In its most basic form, according to some example embodiments of the present invention, the apparatus 10 or its processor 11 (i.e. a processing system thereof) is configured to perform configuring a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and scheduling common control signaling in the one subset of physical resource blocks in accordance with the configured broadcast channel of the carrier.

Accordingly, stated in other words, the apparatus 10 at least includes respective means for configuring a broadcast channel and means for scheduling common control signaling.

In its most basic form, according to some example embodiments of the present invention, the apparatus 20 or its processor 21 (i.e. a processing system thereof) is configured to perform detecting a broadcast channel of a carrier in one of a predetermined number of subsets of physical resource blocks in a system bandwidth, wherein each subset includes the same prescribed number of physical resource blocks and the predetermined number of subsets are distributed in the frequency domain to cover the system bandwidth with the center of the system bandwidth being located in the center of a middle subset, and listening for (or monitoring) common control signaling in the one subset of physical resource blocks in accordance with the detected broadcast channel of the carrier.

Accordingly, stated in other words, the apparatus 20 at least includes respective means for detecting a broadcast channel and means for listening for (or monitoring) common control signaling.

For further details of specifics regarding functionalities according to some example embodiments of the present invention, reference is made to the foregoing description in conjunction with FIGS. 1 to 4.

According to some example embodiments of the present invention, a system may include any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package, or a (hardware) module including such chip or chipset; this, however, does not exclude the possibility that a functionality of a device/apparatus or module, instead of being hardware implemented, be implemented as software in a (software) module such as a computer program or a computer program product including executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description includes software code as such including code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, some examples of the present invention provide measures for a broadcast channel configuration of a standalone carrier. Such measures may exemplarily include measures for configuring a broadcast channel of a carrier in one of a predetermined number of subsets of physical resource blocks in a system bandwidth on the basis of a cell configuration, wherein each subset includes the same prescribed number of physical resource blocks and the predetermined number of subsets are distributed in the frequency domain to cover the system bandwidth with the center of the system bandwidth being located in the center of a middle subset, and measures for scheduling common control signaling in the one subset of physical resource blocks in accordance with the configured broadcast channel of the carrier.

Even though some examples of the present invention are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP Third Generation Partnership Project
BW Bandwidth
CA Carrier Aggregation
CC Component Carrier
C-RNTI Connection RNTI
CRC Cyclic Redundancy Check
CRS Common Reference Signal
CSS Common Search Space
DL Downlink
DL-SCH DL Shared CHannel
eNB evolved Node B (E-UTRAN base station)
EPC Evolved Packet Core
ePDCCH Enhanced Physical Downlink Control Channel
E-UTRAN Evolved UTRAN
IEEE Institute of Electrical and Electronics Engineers
LTE Long Term Evolution
LTE-A Long Term Evolution Advanced
MIB Master Information Block
NCT New Carrier Type
OFDM Orthogonal Frequency Division Multiplexing
PBCH Physical Broadcast CHannel
PCC Primary Cell Carrier
PCI Physical Cell Identity
PDCCH Physical Downlink Control CHannel
PDSCH Physical Downlink Shared CHannel
PRB Physical Resource Block
P-RNTI Paging RNTI
PSS Primary Synchronization Signal
RNTI Radio Network Temporary Identifier
RACH Random Access Channel
RA-RNTI Radio Access RNTI
RF Radio Frequency
RRC Radio Resource Control
RS Reference Signal
SCC Secondary Cell Carrier
SI System Information
SIB System Information Block
SI-RNTI System Information RNTI
SNR Signal to Noise Ratio
SSS Secondary Synchronization Signal
TPC Transmit Power Control
TPC-RNTI Transmit Power Control RNTI
UE User Equipment
UL Uplink
USS UE-specific Search Space
UTRAN UMTS Terrestrial Radio Access Network
UMTS Universal Mobile Telecommunications System

1. A wireless communication method comprising:
configuring a broadcast channel of a carrier in one of a predetermined number of subsets of physical resource blocks in a system bandwidth on the basis of a cell configuration, wherein each subset comprises the same prescribed number of physical resource blocks and the predetermined number of subsets are distributed in the frequency domain to cover the system bandwidth with the center of the system bandwidth being located in the center of a middle subset, and
scheduling common control signaling in the one subset of physical resource blocks in accordance with the configured broadcast channel of the carrier.

2. The method according to claim 1, wherein at least one of:
the broadcast channel is configured in the one subset of physical resource blocks on the basis of a physical cell identity and the number of subsets in the system bandwidth,
a master information block of the common control signaling is scheduled on a physical broadcast channel in the one subset of physical resource blocks,
a system information block of the common control signaling is scheduled on a physical downlink shared channel in the one subset of physical resource blocks,
a common search space for an enhanced physical downlink control channel is formed around the center of the one subset of physical resource blocks,
the method is operable at or by a base station of a cell of a cellular communication system, and/or
the carrier comprises a standalone carrier of a non-backwards compatible carrier type and/or is usable as a component carrier in carrier aggregation.

3. The method according to claim 1, further comprising
issuing the scheduled common control signaling in the one subset of physical resource blocks such that the scheduled common control signaling is transmitted with a predefined timing and scrambling scheme and/or with a predefined synchronization scheme and/or with the same at least one antenna port for the common control signaling in one or more of a master information block, a system information block and an enhanced physical downlink control channel.

4. A wireless communication method comprising:
detecting a broadcast channel of a carrier in one of a predetermined number of subsets of physical resource blocks in a system bandwidth, wherein each subset comprises the same prescribed number of physical resource blocks and the predetermined number of subsets are distributed in the frequency domain to cover the system bandwidth with the center of the system bandwidth being located in the center of a middle subset, and
listening for common control signaling in the one subset of physical resource blocks in accordance with the detected broadcast channel of the carrier.

5. The method according to claim 4, wherein at least one of:
detecting the broadcast channel of the carrier comprises:
detecting a synchronization signal in the middle subset in the system bandwidth, and
detecting a master information block in each subset of physical resource blocks in the system bandwidth after detection of the synchronization signal,
a master information block of the common control signaling is listened for on a physical broadcast channel in the one subset of physical resource blocks,
a system information block of the common control signaling is listened for on a physical downlink shared channel in the one subset of physical resource blocks,
common control signaling in an enhanced physical downlink control channel is listened for in a common search space for the enhanced physical downlink control channel, which is formed around the center of the one subset of physical resource blocks,
the method is operable at or by a terminal operable in a cell of a cellular communication system, and/or
the carrier comprises a standalone carrier of a non-backwards compatible carrier type and/or is usable as a component carrier in carrier aggregation.

6. The method according to claim 4, further comprising
obtaining the common control signaling in the one subset of physical resource blocks after receiving the common control signaling with a predefined timing and scrambling scheme and/or with a predefined synchronization scheme and/or with the same at least one antenna port for the common control signaling in one or more of a master information block, a system information block and an enhanced physical downlink control channel.

7. An apparatus comprising a processing system for use on a network side of a cellular communication system, the apparatus arranged to:
configure a broadcast channel of a carrier in one of a predetermined number of subsets of physical resource blocks in a system bandwidth on the basis of a cell configuration, wherein each subset comprises the same prescribed number of physical resource blocks and the predetermined number of subsets are distributed in the frequency domain to cover the system bandwidth with the center of the system bandwidth being located in the center of a middle subset, and
schedule common control signaling in the one subset of physical resource blocks in accordance with the configured broadcast channel of the carrier.

8. The apparatus according to claim 7, wherein the apparatus is arranged to at least one of:
configure the broadcast channel in the one subset of physical resource blocks on the basis of a physical cell identity and the number of subsets in the system bandwidth,
schedule a master information block of the common control signaling on a physical broadcast channel in the one subset of physical resource blocks,
schedule a system information block of the common control signaling on a physical downlink shared channel in the one subset of physical resource blocks,
perform such that a common search space for an enhanced physical downlink control channel is formed around the center of the one subset of physical resource blocks, and
issue the scheduled common control signaling in the one subset of physical resource blocks such that the scheduled common control signaling is transmitted with a predefined timing and scrambling scheme and/or with a predefined synchronization scheme and/or with the same at least one antenna port for the common control signaling in one or more of a master information block, a system information block and an enhanced physical downlink control channel.

9. The apparatus according to claim 7, wherein
the apparatus is operable as or at a base station of a cell of a cellular communication system, and/or
the carrier comprises a standalone carrier of a non-backwards compatible carrier type and/or is usable as a component carrier in carrier aggregation.

10. The apparatus according to claim 9, wherein
the cellular communication system comprises a Long Term Evolution (LTE) or Long Term Evolution Advanced (LTE-A) communication system.

11. An apparatus comprising a processing system for use on a terminal side of a cellular communication system, arranged to:
detect a broadcast channel of a carrier in one of a predetermined number of subsets of physical resource blocks in a system bandwidth, wherein each subset comprises the same prescribed number of physical resource blocks and the predetermined number of subsets are distributed in the frequency domain to cover the system bandwidth with the center of the system bandwidth being located in the center of a middle subset, and
listen for common control signaling in the one subset of physical resource blocks in accordance with the detected broadcast channel of the carrier.

12. The apparatus according to claim 11, arranged to detect the broadcast channel of the carrier by:
detecting a synchronization signal in the middle subset in the system bandwidth, and
detecting a master information block in each subset of physical resource blocks in the system bandwidth after detection of the synchronization signal.

13. The apparatus according to claim 11, arranged to listen for a master information block of the common control signaling on a physical broadcast channel in the one subset of physical resource blocks.

14. The apparatus according to claim 11, arranged to listen for a system information block of the common control signaling on a physical downlink shared channel in the one subset of physical resource blocks.

15. The apparatus according to claim 11, arranged to listen for common control signaling in an enhanced physical downlink control channel in a common search space for the enhanced physical downlink control channel, which is formed around the center of the one subset of physical resource blocks.

16. The apparatus according to claim 11, arranged to:
obtain the common control signaling in the one subset of physical resource blocks after receiving the common control signaling with a predefined timing and scrambling scheme and/or with a predefined synchronization scheme and/or with the same at least one antenna port for the common control signaling in one or more of a master information block, a system information block and an enhanced physical downlink control channel.

17. The apparatus according to claim 11, wherein
the apparatus is operable as or at a terminal operable in a cell of a cellular communication system, and/or
the carrier comprises a standalone carrier of a non-backwards compatible carrier type and/or is usable as a component carrier in carrier aggregation.

18. An apparatus according to claim 17, wherein
the cellular communication system comprises a Long Term Evolution (LTE) or Long Term Evolution Advanced (LTE-A) communication system.

19. A non-transitory computer-readable storage medium comprising computer program code which when executed by a data processing system, causes the data-processing system to carry out the method according to claim 1.
